(19) United States
(12) Patent Application Publication
(10) Pub. No.: US 2008/0004953 A1
(43) Pub. Date: Jan. 3, 2008

(54) Public Display Network For Online Advertising

(75) Inventors: Wei-Ying Ma, Beijing (CN); Lei Zhang, Beijing (CN); Minjing Li, Beijing (CN)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/428,204

(22) Filed: Jun. 30, 2006

(51) Int. Cl. G06Q 30/00

(52) U.S. Cl. 705/14

(57) ABSTRACT

A public advertising system uses sensors at each public display to gather characteristics of audiences at each of multiple locations. In one implementation, the system compiles the audience characteristics into an audience distribution model. The audience distribution model matches advertising content to audiences and also selects locations, times, and durations for creating distribution strategies. Such distribution strategies provide advertisers with a cost-effective business tool. The system can also match advertising to target features of an audience in real time. In one implementation, computer vision and speech recognition provide rigorous analysis of audience characteristics.

### BACKGROUND

Electronic displays for public advertising and for providing dynamic information are becoming more and more common, especially as their prices drops in many parts of the world. Unlike conventional billboards, some electronic advertising displays include electronics for providing audio or controlling animated images on the display. Thus, very large electronic advertising display panels may be found high above street level over busy downtown streets, while smaller versions may be found in stores, airports, elevators, automatic teller machines (ATMs), public transportation vehicles, etc. Kiosks for advertising to one or two people at a time may also be found in many settings.

Advertising strategies for electronic displays tend to adopt a conventional approach, because of advertising's history. Before electronic displays were possible, advertisements were posted on paper, for example, and such relatively permanent media dictated that advertisements were not very dynamic, but persisted in their assigned location long enough to justify the price of leasing the advertising space. In many cases, advertising strategies were obvious. Along a highway, a prospective advertiser could fairly easily calculate the character of automobile drivers that would be viewing a billboard in a certain location.

Now that electronic advertising displays have more capabilities and can be made smaller yet more eye-catching with dynamic color and animation, more electronic panels and kiosks are appearing, especially in high-population areas. However, in areas of high population density, the viewing audience is transient—for example people quickly move by an advertisement on a busy street or in an elevator and so an advertiser misses many opportunities to relay information or to make a sale if the advertising displays cater to only one segment of the public.

Moreover, the online advertising market is accelerating in recent years. The U.S. market for online advertising was about $7.3 billion in 2003 and approximately $9.1 billion in 2004, for example. Further growth is predicted for online advertising. Yet as it acquires market share from the overall advertising market, online advertising still remains a very tiny part of overall advertising.

Direct mail, newspaper, and television are still three major advertising channels besides online advertising to be used by companies to build their brand name, public image, and to bring awareness about new products. Search-based online advertising as performed in conjunction with computer search engines is unlikely to be able to replace these three major advertising channels. Because advertising that merely accompanies computer searches is non-transactional and non-interactive in nature, the model of letting advertisers buy advertising to appear alongside computer search tools is unlikely to attract the money that is currently spent in conventional advertising categories.

### SUMMARY

A public advertising system uses sensors at each public display to gather characteristics of audiences at each of multiple locations. In one implementation, the system compiles the audience characteristics into an audience distribution model. The audience distribution model matches advertising content to audiences and also selects locations, times, and durations for creating distribution strategies. Such distribution strategies provide advertisers with a cost-effective business tool. The system can also match advertising to target features of an audience in real time. In one implementation, computer vision and speech recognition provide rigorous analysis of audience characteristics.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagram of an exemplary public advertising display.

FIG. 2 is a block diagram of an exemplary public display system.

FIG. 3 is a diagram of an exemplary public display network.

FIG. 4 is a block diagram of an exemplary client-side public advertising engine.

FIG. 5 is a diagram of exemplary detection of audience characteristics.

FIG. 6 is a block diagram of an exemplary server-side public advertising engine.

FIG. 7 is a flow diagram of an exemplary method of online public advertising.

FIG. 8 is a block diagram of an exemplary computing system suitable for hosting components of exemplary public advertising engines.

### DETAILED DESCRIPTION

### Overview

Described herein are systems and methods for networking public displays to create online advertising. First, a public display may be a large electronic flatscreen display monitor or reader-board, an LCD display, a cathode ray tube (CRT) screen, a billboard and projector combination, a kiosk display, an ATM readout, a public phone display screen, etc.

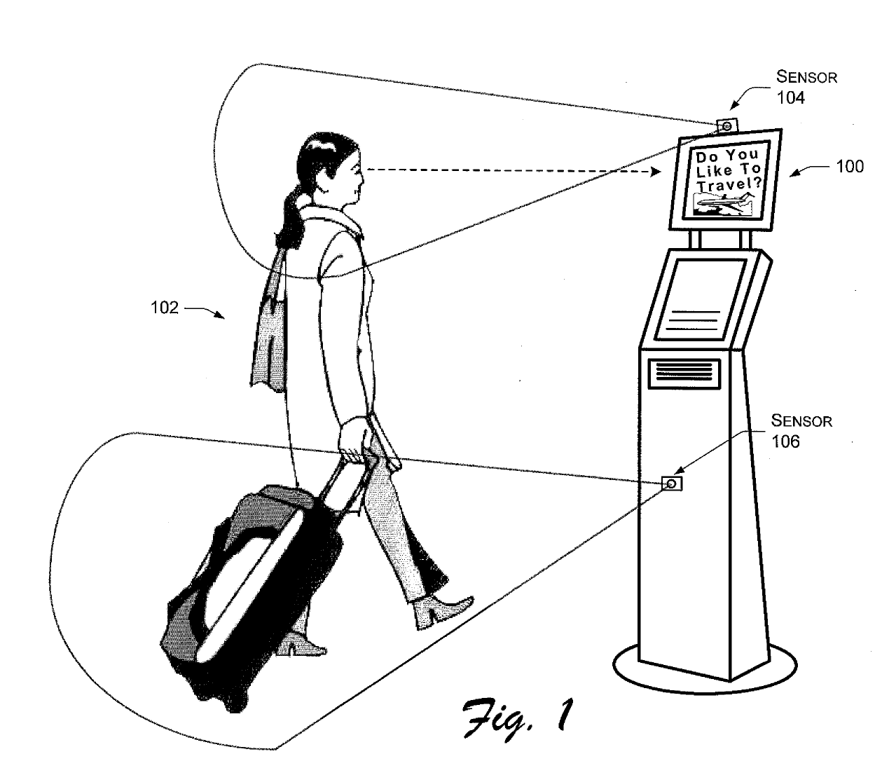

In one implementation, a public display network responds to a current audience in proximity to a public display. As shown in FIG. 1, an example public display 100 senses a current audience, such as an individual 102, and the associated network matches advertising to the individual 102. The public display network can gather information about a viewer via several types and locations of sensors (e.g., 104, 106) at a given display 100.

An exemplary public display network may also gather demographic information about a fluctuating audience at many individual displays spread over a geographical area. The gathered information may be compiled and subjected to analysis in order to formulate advertising strategies including target population segment, advertisement selection, time and location of advertising, and degree of coverage for a geographical area. Public displays may include some displays that are computationally interactive, e.g., responsive to a viewer's queries via keyboard, mouse, touch-screen, cell phone, etc., to dynamically display advertising that is relevant to the viewer and location in which the display is located. For example, a camera on the display may detect that the viewer is a teenager and tailor the content or vocabulary of advertisements to suit the age group.

### Exemplary System

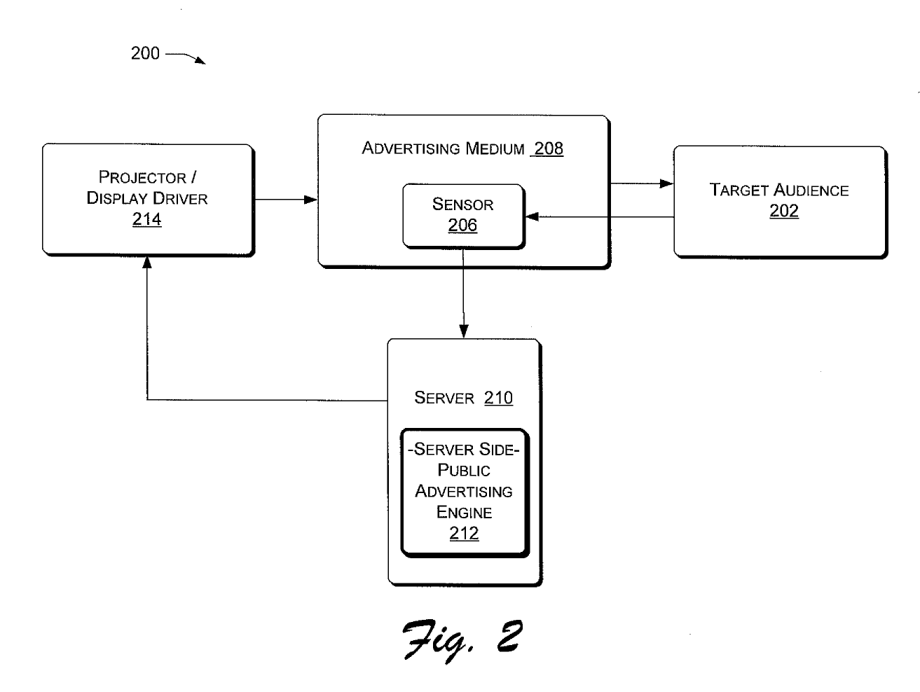

FIG. 2 shows a basic exemplary architecture 200 for public advertising that is responsive to a target audience 202, such as a crowd. One or more sensors 206 that may be associated with a location of an advertising medium 208 detects characteristics of the target audience 202, such as presence at display, number of people, facial features, age groups, distinctive features, significant clothes and personal effects, etc. An onsite or remote server 210 receives input from the sensor(s) 206. The server 210 hosts a server-side public advertising engine 212 that analyzes and interprets the input from the sensor 206. Then, the public advertising engine 212 directs advertising to the target audience 202 via a display driver 214 (projector, client computer, or other intermediary) and subsequently, to the advertising medium 208 itself.

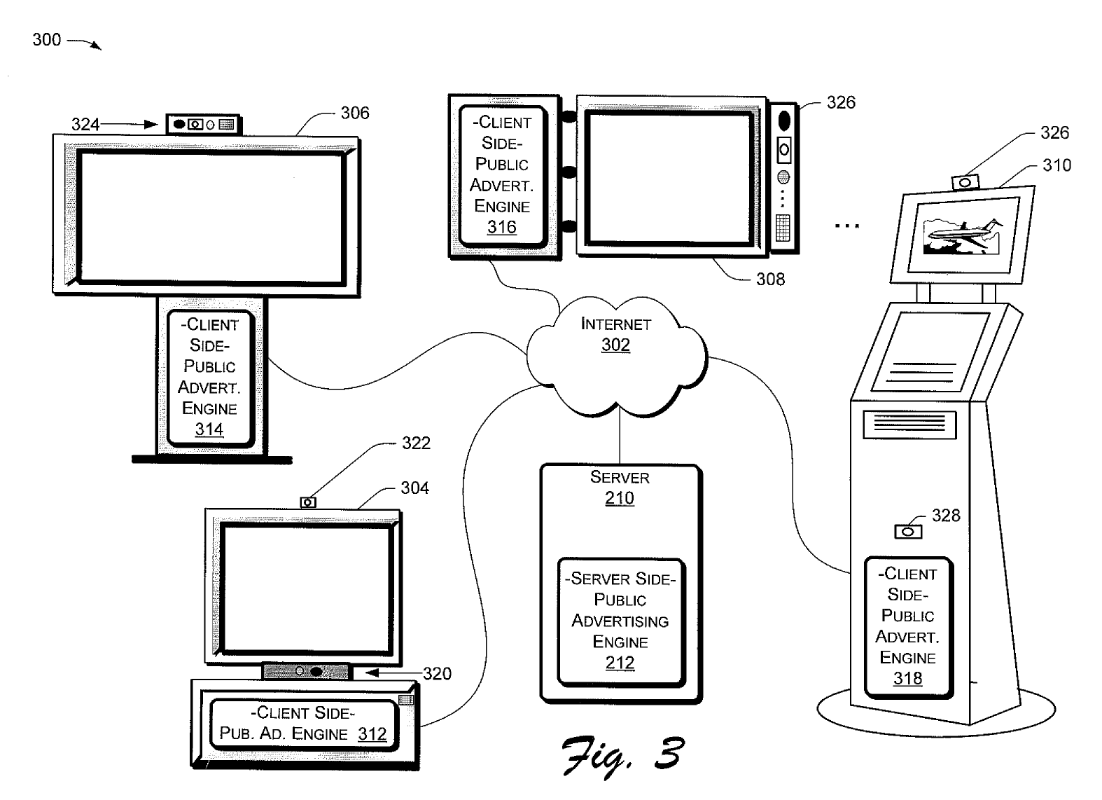

FIG. 3 shows another exemplary system, a public display network 300 in which the server 210 and the server-side public advertising engine 212 are coupled via the Internet 302 with multiple clients. The multiple clients may include a publicly available computing device 304, a large public electronic reader-board 306, a public information display 308, a public kiosk display 310, etc.

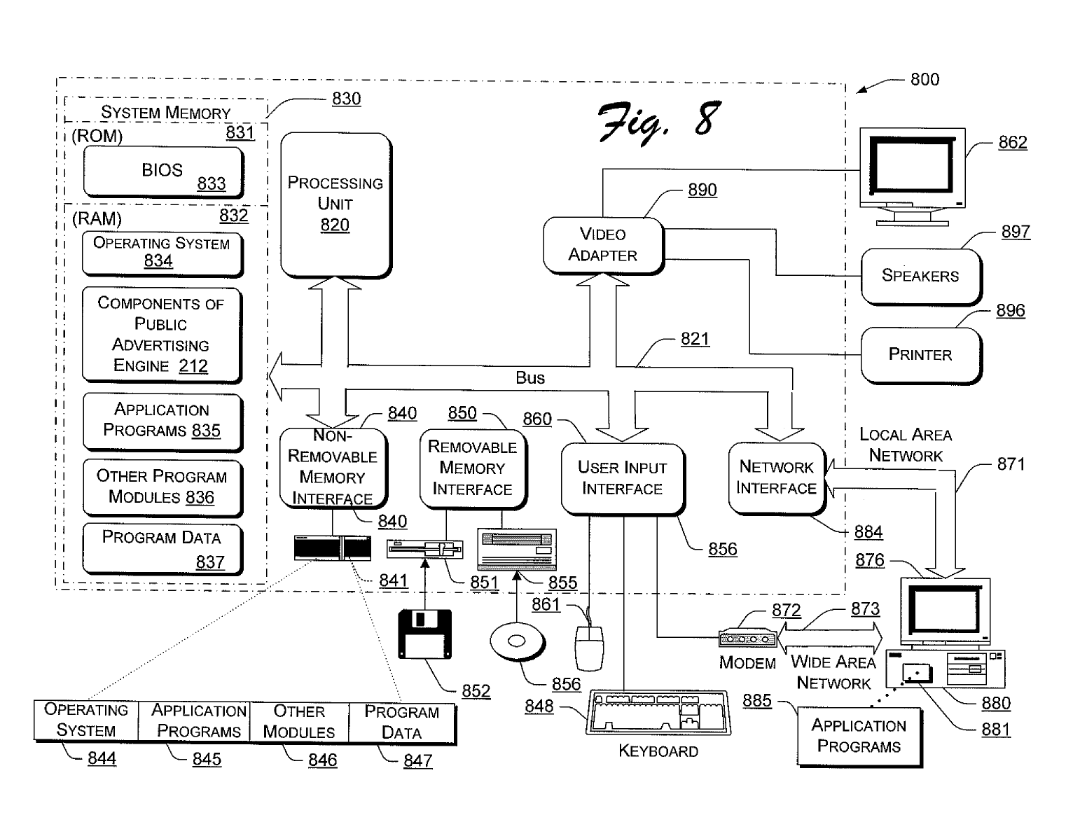

In the shown implementation, the server-side public advertising engine 212 may be in one location, as shown, or may consist of distributed engines spread over many servers in various locations (not shown). In the illustrated implementation, the server-side engine 212 is in communication with a client-side engine for each display in the public display network 300, that is, client-side engines 312, 314, 316, and, 318. Each client-side engine is typically coupled with one or more local sensors, for example, the illustrated sensors and banks of sensors 320, 322, 324, 326, . . . , 328, for detecting the presence of people in proximity to a display and gathering information about the audience. A description of an example computing device for hosting a server-side public advertising engine 212 or a client-side public advertising engine 312 is provided below with respect to FIG. 8.

### Exemplary Client-Side Engine

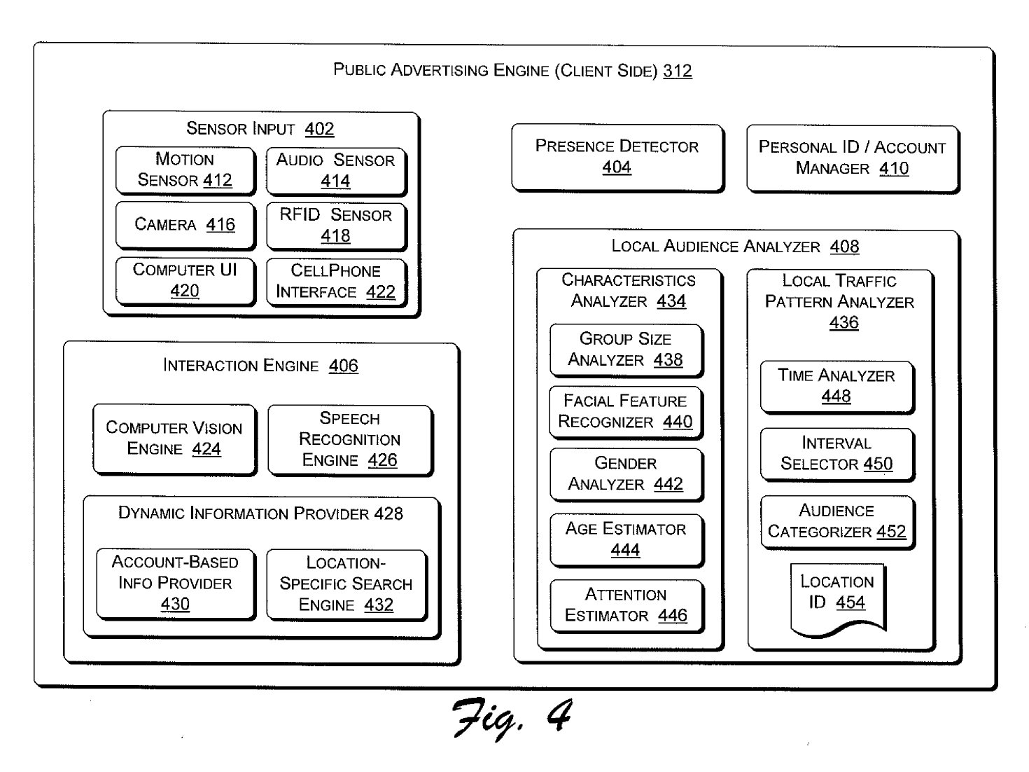

FIG. 4 shows the exemplary client-side public advertising engine 312 of FIG. 3 in greater detail. The illustrated configuration of the client-side public advertising engine 312 is meant to provide only one example arrangement for the sake of overview. Many other arrangements of the illustrated components, or similar components, are possible within the scope of the subject matter Such an exemplary client-side public advertising engine 312 can be executed in hardware; (e.g., the sensors); software; or combinations of hardware, software, firmware, etc.

The exemplary client-side public advertising engine 312 includes a bank of sensors 402, a presence detector 404 to sense presence or absence of people near a display, an interaction engine 406, a local audience analyzer 408, and a personal ID/account manager 410.

The sensor input (bank of sensors, or just “sensors” 402) may include one or more of the following sensors: an infrared motion sensor 412, an audio sensor 414, a camera 416, a radio frequency ID (RFID) sensor 418, a computer user interface 420, a cell phone interface 422, etc. This list of sensors 402 is not exhaustive. Other sensors that detect the presence and characteristics of people near a public display may also be included. The sensors can be remote from the client-side public advertising engine 312 in a given client display and can even be remote from the display itself, e.g., to measure audience traffic patterns as people approach the display from different locations.

The interaction engine 406 may include a computer vision engine 424 and a speech recognition engine 426 to process input from the sensors 402 in order to recognize audience characteristics by means of images and speech—i.e., “sight and sound.” The interaction engine 406 may also include a dynamic information provider 428 that has an account-based information provider 430 and a location-based search engine 432.

The interaction engine 406 improves upon a conventional search engine by incorporating input from the sensors 402 to modify or “color” the search. The public user may or may not decide to login via the account manager 410 to a particular public client, such as a public kiosk 310, when the client has Internet access. With or without login, the public advertising engine 318 associated with the client can use current characteristics of the user, as gathered by the sensors 402, to enhance search results. Thus, the public display network 300 may have superior and more up-to-date knowledge of the user and superior knowledge of current local resources than a conventional general-purpose search engine. The public display network 300 may be able to apply the currently available local resources to the user with increased relevance because the public advertising engine 318 also has a more thorough database of current local demographics as gathered by the other multiple public displays of the network in the same city, neighborhood, street, or other geographic area.

The local audience analyzer 408 includes a characteristics analyzer 434 for determining and interpreting—e.g., via the sensors 402—significant features of people near a given client display, and a local traffic pattern analyzer 436 to compile time and location statistics with respect to the changing audience passing by the associated client display.

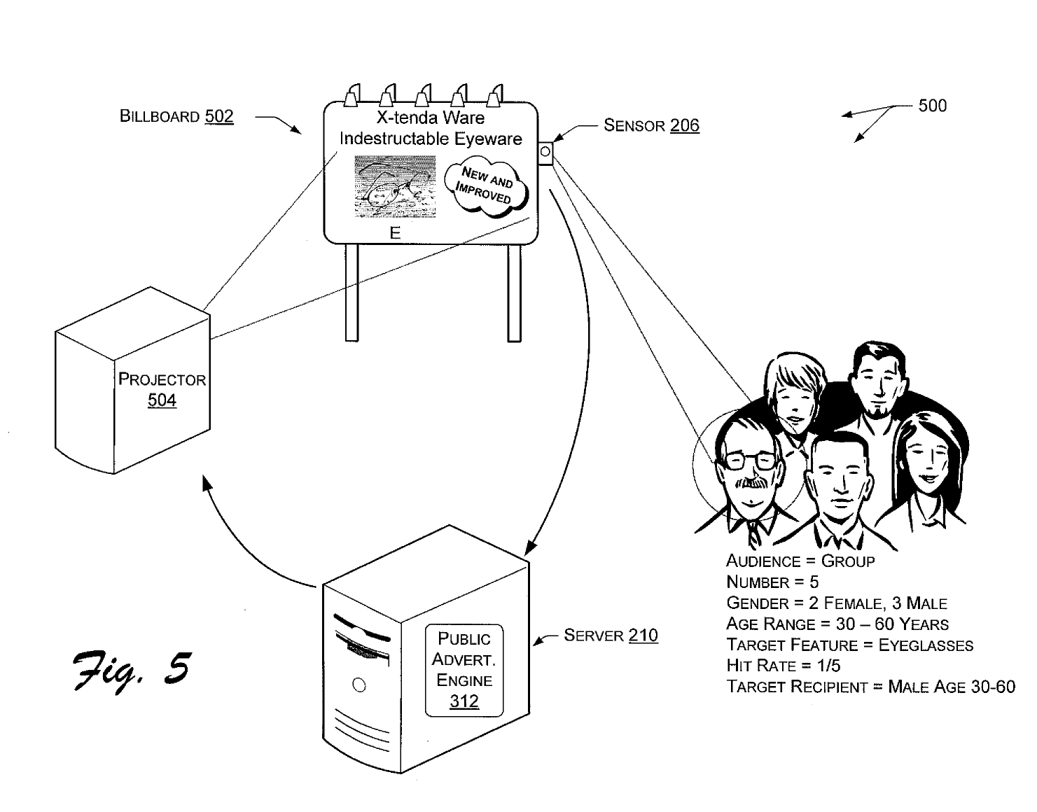

As shown in FIG. 5, an implementation of the characteristics analyzer 434 of FIG. 4 drives an implementation of an exemplary public display network 500 that includes a conventional billboard surface 502 animated by a projector 504. A server 210 includes an implementation of the client-side public advertising engine 312 as well as components of the server-side engine 212 (not shown). The characteristics analyzer 434 may include a group size analyzer 438 to interpret the number of people present, a facial feature recognizer 440, a gender analyzer 442, an age estimator 444 to discern the age of a human viewer or a mixture of ages in the group, and an attention estimator 446 to interpret a degree of interest in a current display presentation based on, for example, degree of movement, facial intent, expressions, body language, etc.

Returning to FIG. 4, the local traffic pattern analyzer 436 includes an interval selector 450 to designate a time period, for example, rush hour. The audience categorizer 452 receives input from the characteristics analyzer 434 and together with the time analyzer 448 associates various types of people and their characteristics, with time patterns. For example, the local traffic pattern analyzer 436 may determine that at a given time each day there is an interval where most passers-by are schoolchildren.

The location ID 454 is a stored identifier that can be used to identify a given client-side public advertising engine 312 to a central server-side engine 212 and to other clients in the same public display network 300. For example, the location ID 454 may be used to brand results from the local audience analyzer 408 so that a central server 210 can compile meaningful statistical demographic supported by many locations in a region.

In general, the client-side public advertising engine 312 detects an audience at a particular display and performs some front-end analysis of the audience. This pre-digested but still only locally relevant data-preliminary analyses-are sent to the server-side engine 212.

In one implementation, the presence detector 404 may act as a gatekeeper for detecting whether people are present. If they are not, the associated display may shut down to save energy or play a default advertisement or even present a catchy advertisement to lure people to the display. The presence detector may consist of light or sound sensors, a pressure pad, an infrared presence detector, etc.

If an audience is detected, then sensor input 402 is collected. The illustrated bank of sensors 402 is not exclusive of additional sensors that could be added. The motion sensor 412, camera 416, and audio sensor 414 gather input for the computer vision engine 424 and speech recognition module 426. These in turn may use known techniques to identify characteristics and features of the audience that can be analyzed in order to select or modify advertising. For example, the computer vision engine 424 may associate a pink dress with the female gender, or a mustached face with the male gender.

The speech recognition engine 426 may differentiate tonal frequencies of voices into ranges to categorize audience members. Not all data generated by the sensors 402 has to be sent to the computer vision engine 424 or the speech recognition engine 426. The characteristics analyzer 434 may recruit input from the sensors 402 for audience analysis using simple combinations of the different data. For example, an image of a person from the camera 416 combined with sensing little movement via the motion sensor 412 may indicate that a viewer's attention is highly focused on an advertisement.

Other sensors 402 can include the RFID sensor 418 to detect from a distance various products or ID cards that a person may be carrying. The public display network 300 may then interpret the particular product or ID as an opening for presenting advertising that is not presented to everybody.

Some displays may have a computer user interface (UI) 420 and/or a cell phone interface 422 for transactional capabilities. For a cell phone interface 422, a phone number may be associated with the particular kiosk or display—this does not mean that the display must have wireless transmission ability. The telephone number allows the audience to call for information or order goods and services. Such a kiosk may offer free wireless Internet, however, and tailor advertising to a user who is in proximity. The dynamic information provider 428 can offer both account-based information 430 and location specific searches 432, in which the local kiosk has intimate and superior knowledge of goods and services immediately available in very close proximity of the display. If a certain query is received often by such a display, then the display may offer “frequently asked question” FAQ information voluntarily.

The local audience analyzer 408 analyzes audience characteristics (434) against local traffic patterns (436). Accordingly, the characteristics analyzer 434 breaks down features of an audience associated with a particular traffic pattern (or time) using the group size analyzer 438, facial feature recognizer 440, gender analyzer 442, age estimator 444, and attention estimator 446, etc., (this list is not meant to be exhaustive). In many cases, sophisticated computer vision and speech recognition technologies are not needed to identify some types of audiences in some types of locations. For example, at a shopping mall near a school, a group of school children passing through during the half hour after school can be reliably detected with a few inexpensive sensors and not much programming logic. With the more sophisticated components, such as the computer vision engine 424, the characterization of people can be honed considerably. For example, the engine 312 might filter gender and product use pattern based on observation of lipstick shades and presence of two earrings greater than a certain length.

The local traffic pattern analyzer 436 correlates audiences with times, e.g., via the time analyzer 448, or with traffic patterns in implementations that have sensors 402 deployed to detect different avenues by which people might approach a display. In one mode, the audience categorizer 452 makes an initial assessment of the audience versus the time of day and amount of time spent at the display. In other words, the components are simply sensing and measuring the presence of an audience and how long they interact with the display. Conversely, in another mode, the interval selector 450 chooses a time interval, for example, “lunch hour” and the audience categorizer 452 gauges the audiences that interact during this time period. Each location is branded with a location ID 454 so that the central, server-side engine 212 can compile results across numerous locations.

### Exemplary Server-Side Engine

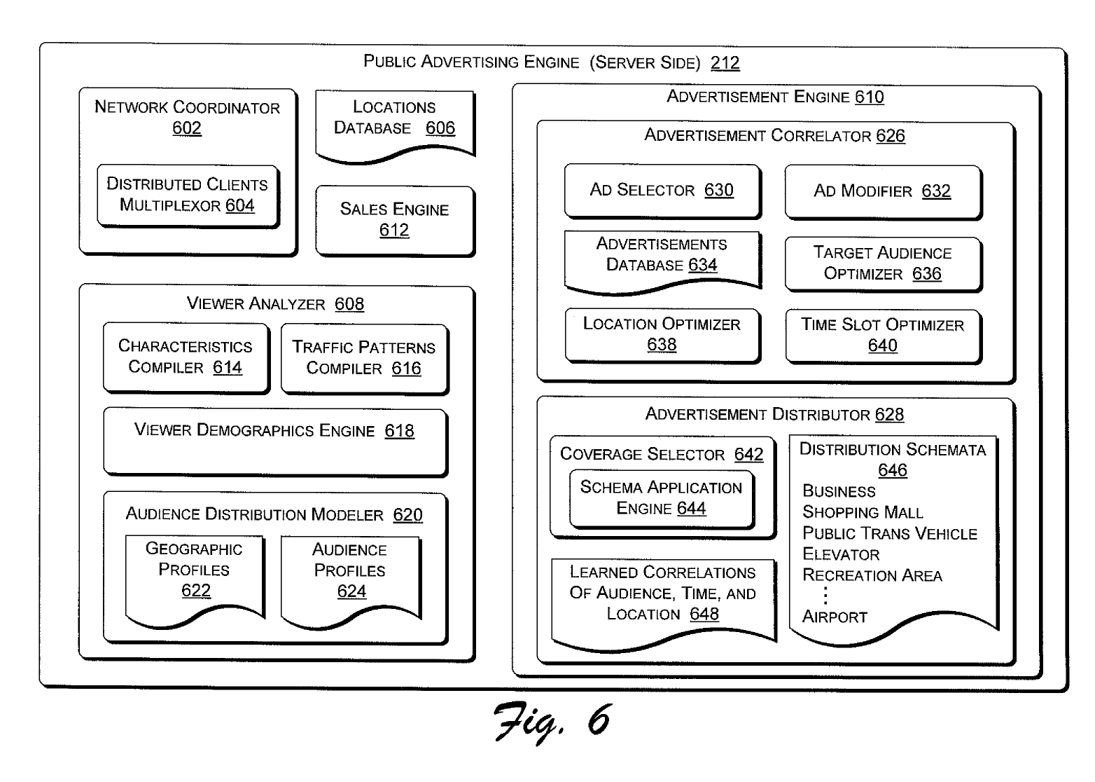

FIG. 6 shows the exemplary server-side public advertising engine 212 of FIGS. 2-3 in greater detail. Like the exemplary client-side engine 312, the illustrated configuration of the server-side public advertising engine 212 is meant to provide only one example arrangement for the sake of overview Many other arrangements of the illustrated components, or similar components, are possible within the scope of the subject matter. Such an exemplary server-side public advertising engine 212 can be executed in hardware, software, or combinations of hardware, software, firmware, etc.

The exemplary server-side engine 212 coordinates multiple public displays, as shown in FIG. 3, and thus includes a network coordinator 602 that may further include a distributed clients multiplexor 604. In the most typical Internet implementation, the multiplexor 604 may be software or hardware that sends and receives communications, such as commands and advertising content, to various clients using their IP addresses, e.g., as retrieved from a locations database 606.

The exemplary server-side engine 212 also includes a viewer analyzer 608 and an advertisement engine 610. The viewer analyzer 608 processes audience information received from numerous public displays, usually spread over many locations. The advertisement engine 610 matches advertising content to a particular audience, or at least modifies the content to match the audience.

The viewer analyzer 608 compiles input from one or more public displays into central information for strategizing and disseminating the advertising. That is, input from one public display may determine what is presented on another. In one implementation, the viewer analyzer 608 includes a characteristics compiler 614, a traffic patterns compiler 616, a viewer demographics engine 618, and an audience distribution modeler 620. The audience distribution modeler 620 may further include geographic profiles 622 and audience profiles 624.

In one implementation, the advertisement engine 610 has two modes. In a first mode, the advertisement engine 610 matches a person currently being detected in proximity to a public display with suitable advertisements or at least modifies the content of an advertisement to suit the audience. In a second mode, the advertisement engine 610 uses audience profiles that have been learned through past audience analysis and uses pre-designed presentation schemata to proactively promote advertisements at a particular time and location based on these past analyses and not necessarily on current sensor input, although the latter is not ruled out. Thus, in the second mode, the sensors 402 may or may not be utilized to enhance the advertising to be displayed, even though the advertising is still optimized for the audience calculated to be present at certain times. In one implementation, a sales engine 612 is also included to optimize buying and selling opportunities to public kiosks and displays that have transactional capabilities entered into through the personal ID/account manager 410.

Given that the public advertising engine (server-side) 212 can sense and intelligently understand and interpret an audience and audience characteristics, the advertisement engine 610 interprets probable audience needs and sensibilities in order to apply relevant advertising to audience members near a public display. This occurs whether the audience is detected by sensors in real time or the audience is known to appear at a public display at certain times based on analysis of past results.

The illustrated advertisement engine 610 includes an advertisement correlator 626 for optimizing matches between audience and advertisement, and an advertisement distributor 628 for interacting with audiences through disseminated advertising.

The advertisement correlator 626 includes an advertisement selector 630, an advertisement modifier 632, an advertisements database 634, a target audience optimizer 636, a location optimizer 638, and a time slot optimizer 640.

The advertisement distributor 628 further includes a coverage selector 642, which may further have a schema application engine 644, a database of distribution schemata 646, and a learned correlations database, such as a learned audience, time, and location correlations database 648.

In general, the server-side public advertising engine 212 receives data from one or more remote displays arranged in different locations across a public display network 300 and returns advertising and/or an advertising strategy based on an audience at the display(s), or based on analysis of past audiences and traffic patterns at the display(s).

The distributed clients multiplexor 604 of the network coordinator 602 receives sensory data or preliminary analyses from one or more of the client-side engines 312 for purposes of returning relevant advertising or for further analysis.

The characteristics compiler 614 of the viewer analyzer 608 examines audience characteristics from one display or across many displays and applies statistical analysis, comparison with desirable target audiences, compilation with previously compiled results, etc. Likewise, the traffic patterns compiler 616 gains a broader perspective of one display's audience participation and traffic patterns in the context of all the displays in a public display network 300. The results of the characteristics compiler 614 and the traffic patterns compiler 616 can be distilled by the viewer demographics engine 618 into useful and practical demographics that can be passed to the audience distribution modeler 620 to form the geographic profiles 622 and audience profiles 624 of populations that are available to be advertised to, how to attract desirable targets to displays, and where and when to advertise. For example, an exemplary display at the door of a beauty parlor generates an audience profile 624 that indicates women are the primary viewers in that location.

The advertisement engine 610 has a advertisement correlator 626 that matches advertising to audience and circumstance. Based on input from the viewer analyzer 608, multiple optimizers, such as the target audience optimizer 636, the location optimizer 638, and the time slot optimizer 640 process the input in order to best correlate an ad with an audience, a location, and a time. Thus, the ad selector 630 selects advertising from the advertisements database 634 based on optimized parameters. In some cases the selection itself of which ad(s) to display is based on the audience and other parameters, but in other cases the ad is designated to be presented at a specific time regardless of audience (“no matter what”) but the content is customized by the ad modifier 632 to suit the particular audience at each display at a certain time and location.

The advertisement distributor 628 provides the final advertising strategy according to a database of learned audience, time, and location correlations 648. In one implementation, a coverage selector 642 determines where and for how long to advertise, based in some cases on favorable display locations selected from the locations database 606. A schema application engine 644 can also select a predetermined template for times and locations of distribution. For example, the distribution schemata database 646 may include schemata for targeting audiences associated with businesses, shopping malls, public transportation vehicles, ATM's, elevators, recreation areas, airports, etc. A key feature of the advertisement distributor 628 is that with the compiled data and perhaps in collaboration with the sales engine 612, it allows advertisers to select the best time slot and location according to their budgets or job bids. This means the exemplary public display network 300 provides an efficient, cost-effective business tool—i.e., less cost and greater income because ads are delivered to precisely targeted audiences with accuracy.

Thus, in a typical scenario, a public display network 300 has numerous displays (e.g., 304, 306, 308 , . . . , 310) connected to one or more centralized or distributed servers 210, and transient audiences can interact with the system in some manner. On the one hand, an individual may use a display 100 as an information terminal and search for information on the Internet 302 (in this case, the display 100 changes its work mode to serve a particular user). On the other hand, the presence detector 404 and local audience analyzer 408 via the camera 416 and computer vision engine 424, for example, or other sensors 402 equipped with the display, may detect the existence of people and some characteristics, e.g., the group size analyzer 438 may determine the number of people; the gender analyzer 442 may determine man or woman, girl or boy; the age estimator 444 may determine approximate ages; etc. The sensed images, speech, and other detected information are sent to the server 210 for analysis by the server-side engine 212. The server-side engine 212 then sends targeted still, audio, or video ads to the people currently around the display 100. Accordingly, ad service providers can effectively deliver ads to different displays and select suitable ads to match the audience, or adjust the content of ads according to audience.

### Exemplary Methods

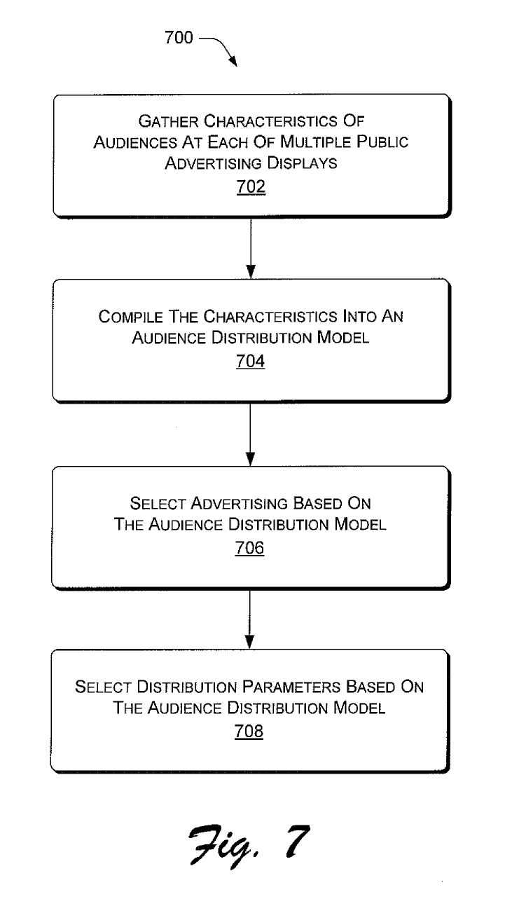

FIG. 7 shows an exemplary method 700 of public display advertising. In the flow diagram, the operations are summarized in individual blocks. Depending on implementation, the exemplary method 700 may be performed by hardware, software, or combinations of hardware, software, firmware, etc., for example, by components of the exemplary client-side public advertising engine 312 or the server-side public advertising engine 212.

At block 702, characteristics of audiences at each of multiple public advertising displays are gathered. The characteristics can include number of people present at each display, genders, ages, facial characteristics, estimation of attention focus, identity of personal effects (purse, glasses, cane, etc.), radio frequency ID's, user-profile information (if the public display offers Internet access), etc. Some implementations may include computer vision (machine vision) techniques and speech recognition techniques to rigorously analyze features of viewers passing by a public display.

At block 704, the detected characteristics and features of the audiences are compiled into an audience distribution model. The audience distribution model typically allows creation of audience profiles and geographical profiles. At this point, advertising may also be matched directly to a detected audience in real time.

At block 706, advertising is selected based on the audience distribution model. Sometimes the selection itself of an advertisement is based on the audience distribution model. At other times only a part of an advertisement is modified in accordance with the audience distribution model, and then the advertisement as a whole is ubiquitously distributed to all public displays in the network or across a particular distribution schema.

At block 708, distribution parameters are selected in accordance with the audience distribution model. Because these distribution parameters are based on the audience distribution model, they provide a basis for cost-effective advertising strategies. In other words, the model is built on learned correlations between audience, location, and time, via sensors at the multiple public displays of an exemplary advertising network. When a distribution strategy uses distribution parameters based on such an audience distribution model—such as locations, times, and durations that maximize reaching a target audience—wasteful advertising, where the message falls on “deaf ears,” is minimized.

### Exemplary Computing Device

FIG. 8 shows an exemplary computing device 800 suitable as an environment for practicing some components of the described subject matter. The components of computing device 800 may include, but are not limited to, a processing unit 820, a system memory 830, and a system bus 821 that couples various system components including the system memory 830 to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (ETSAA) bus, Video Electronics Standards Association (VESA) local bus, and Peripheral Component Interconnect (PCI) bus also known as the Mezzanine bus.

Exemplary computing device 800 typically includes a variety of computing device-readable media. Computing device-readable media can be any available media that can be accessed by computing device 800 and includes nonvolatile media, removable and non-removable media. By way of example, and not limitation, computing device-readable media may comprise storage media. Computing device storage media include, removable and non-removable media implemented in any method or technology for storage of information such as computing device-readable instructions, data structures, program modules, or other data. Computing device storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800.

The system memory 830 includes computing device storage media in the form of volatile and/or nonvolatile memory such as read only memory (ROM) 831 and random access memory (RAM) 832. A basic input/output system 833 (BIOS), containing the basic routines that help to transfer information between elements within computing device 800, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, components of a public advertising engine 212 (or 312), application programs 835, other program modules 836, and program data 837.

The exemplary computing device 800 may also include other removable/non-removable computing device storage media. By way of example only, FIG. 8 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable computing device storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface such as interface 850.

The drives and their associated computing device storage media discussed above and illustrated in FIG. 8 provide storage of computing device-readable instructions, data structures, program modules, and other data for computing device 800. In FIG. 8, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies. A user may enter commands and information into the exemplary computing device 800 through input devices such as a keyboard 848 and pointing device 861, commonly referred to as a mouse, trackball, or touch pad. Other input devices (not shown) may include a microphone, joystick, game pad, satellite dish, scanner, or the like. These and other input devices are often connected to the processing unit 820 through a user input interface 860 that is coupled to the system bus, but may be connected by other interface and bus structures, such as a parallel port, game port, or a universal serial bus (USB). A monitor 862 or other type of display device is also connected to the system bus 821 via an interface, such as a video interface 890. In addition to the monitor 862, computing devices may also include other peripheral output devices such as speakers 897 and printer 896, which may be connected through an output peripheral interface 895.

The exemplary computing device 800 may operate in a networked environment using logical connections to one or more remote computing devices, such as a remote computing device 880. The remote computing device 880 may be a personal computing device, a server, a router, a network PC, a peer device or other common network node, and typically includes many or all of the elements described above relative to computing device 800, although only a memory storage device 881 has been illustrated in FIG. 8. The logical connections depicted in FIG. 8 include a local area network (LAN) 871 and a wide area network (WAN) 873, but may also include other networks. Such networking environments are commonplace in offices, enterprise-wide computing device networks, intranets, and the Internet.

When used in a LAN networking environment, the exemplary computing device 800 is connected to the LAN 871 through a network interface or adapter 870. When used in a WAN networking environment, the exemplary computing device 800 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the exemplary computing device 800, or portions thereof, may be stored in the remote memory storage device. By way of example, and not limitation, FIG. 8 illustrates remote application programs 885 as residing on memory device 881. It will be appreciated that the network connections shown are exemplary and other means of establishing a communications link between the computing devices may be used.

### CONCLUSION

Although exemplary systems and methods have been described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. A method, comprising:
associating one or more sensors with each of multiple public displays;
detecting characteristics of an audience in proximity to each display via the one or more sensors;
selecting advertisements for each display based on the characteristics detected at each display; and
distributing the selected advertisements to the audience at each display.

2. The method as recited in claim 1, wherein the sensors are selected from the group of sensors consisting of a camera, a microphone, a motion detector, a heat detector, a radio frequency identification (RFID) sensor, a pressure pad, a computer input device, and a cell phone input device.

3. The method as recited in claim 1, wherein detecting characteristics includes one of detecting a number of people in the audience, detecting a presence of a person, detecting an image of the person, detecting a voice of the person, detecting a movement of the person, detecting a facial feature of the person, detecting a clothing type of the person, and detecting a personal effect in the vicinity of the person.

4. The method as recited in claim 1, further comprising:
analyzing the detected characteristics to obtain, for at least one member of the audience, a gender of the member, an approximate age of the member, an estimated attention focus of the member, or a recognition of a facial feature of the member; and
selecting an advertisement to display to the member based on the obtained gender, age, estimated attention focus, or recognized facial feature.

5. The method as recited in claim 1, further comprising detecting the characteristics and distributing the advertising in substantially real time.

6. The method as recited in claim 1, further comprising:
combining the detected characteristics from all of the multiple public displays;
analyzing the combined characteristics; and
selecting advertisements for each display based on the analysis of the combined characteristics.

7. The method as recited in claim 1, further comprising:
deriving audience demographics from the characteristics detected at the multiple public displays; and
selecting the advertisements based on the demographics.

8. The method as recited in claim 1, further comprising:
deriving an audience distribution model based on the characteristics of changing audiences detected over time at the multiple public displays;
selecting the advertisements based on the audience distribution model;
distributing the advertisements across at least some of the multiple public displays based on the audience distribution model; and
wherein the audience distribution model statistically correlates the characteristics with times and locations.

9. The method as recited in claim 1, further comprising distributing the advertisements according to schemata that designate times, locations, and durations to display the advertisements, wherein each schema targets a type of audience or a type of location based on an analysis of the combined detected characteristics from the multiple public displays.

10. The method as recited in claim 1, further comprising modifying a part of an advertisement to be shown on substantially all of the public displays, wherein the part to be modified is customized for each public display according to an audience detected at each public display.

11. The method as recited in claim 1, wherein the advertisement to be distributed to one of the multiple public displays is based on at least one characteristic of an audience detected at a different one of the multiple public displays.

12. The method as recited in claim 1, further comprising:
distributing a test advertisement to create reactions in audiences at the multiple public displays;
detecting the characteristics of the audiences to measure the reactions;
selecting advertisements for each display based on the measured reactions.

13. The method as recited in claim 1, further comprising:
compiling the detected characteristics of the audiences of the multiple public displays; and
selecting an advertisement based on the compiled characteristics to lure future audiences to the multiple public displays.

14. A system, comprising:
multiple public displays communicatively coupled into a network;
a server in the network to administer the multiple public displays;
sensors associated with each of the multiple public displays to detect characteristics of an audience at each of the multiple public displays;
an audience analyzer in the network to compile the characteristics; and
an advertisement correlator in the network to select advertisements for display at each of the multiple public displays based on the characteristics detected at each public display and the compiled characteristics.

15. The system as recited in claim 14, further comprising an audience distribution modeler to produce geographic profiles and audience profiles from the compiled characteristics.

16. The system as recited in claim 14, further comprising a computer vision engine to receive input from the sensors and detect the characteristics.

17. The system as recited in claim 14, further comprising a speech recognition engine to receive input from the sensors and detect the characteristics.

18. The system as recited in claim 14, wherein the characteristics analyzer includes one of a group size estimator, a facial feature recognizer, a gender analyzer, an age estimator, or an attention estimator.

19. The system as recited in claim 14, further comprising an advertisement distributor for learning correlations between audience characteristics, locations, and times, wherein the advertisement distributor selects a coverage for displaying an advertisement based on the learned correlations.

20. A computerized public advertising display system, comprising:
means for gathering characteristics of audiences at each of multiple public advertising displays via sensors;
means for compiling the characteristics into an audience distribution model;
means for selecting at least part of an advertising content based on the audience distribution model; and
means for selecting locations, times, and durations for distributing the advertising content based on the audience distribution model.
